(19) United States
(12) Patent Application Publication
(10) Pub. No.: US 2026/0264786 A1
(43) Pub. Date: Sep. 10, 2026

(54) SELF-TENSIONING HOLD DOWN APPARATUS FOR A BICYCLE SUPPORT RACK

(71) Applicant: ETRAILER CORPORATION, Wentzville, MO (US)

(72) Inventors: Michael Schlottach, O'Fallon, MO (US); Kevin Bross, O'Fallon, MO (US); Daniel Perotti, Old Monroe, MO (US); Craig Obermark, Union, MO (US); Robert E. Schulte, St. Paul, MO (US); Corry Blackburn, St. Louis, MO (US)

(21) Appl. No.: 19/070,762

(22) Filed: Mar. 5, 2025

(51) Int. Cl. B62H 3/04; B60R 9/048; B60R 9/10

(52) U.S. Cl. CPC B62H 3/04; B60R 9/048; B60R 9/10

(57) ABSTRACT

A self-tensioning hold down apparatus functions to secure an object to a support rack, for example a bicycle to a bicycle support rack. The apparatus has a catch that exerts a variable force downward on the bicycle that holds the bicycle down on the support rack and compensates for movement of the bicycle on the support rack due to vibration and compensates for any loss of air pressure in the bicycle wheels and thereby prevents the bicycle from falling from the support rack. In a variant embodiment the apparatus has a pair of cradles that exert a variable force upward on the bicycle that holds the bicycle between the cradles and the catch.

### BACKGROUND OF THE INVENTION

There are many different known configurations of bicycle support racks that are designed to support one or more bicycles in upright orientations with the wheels of the bicycles supported on the support racks. On a bicycle support rack of this type, for example a bicycle support rack that is removably attachable to a vehicle, it is important that a bicycle be securely held to the support rack and prevented from falling from the support rack and the vehicle.

FIG. 1 is a schematic representation of a typical construction of a bicycle support rack 10 that is removably attachable to a vehicle. The support rack 10 comprises a wheel channel 12 having a U-shaped cross section configuration. The U-shaped cross section of the wheel channel 12 is dimensioned to receive the front wheel 14 and the rear wheel 16 of a bicycle 18 in the channel as represented in FIG. 1. The wheel channel 12 is supported on mounts 22 that are constructed to be removably attachable to the exterior of a vehicle. For example, the mounts 22 could be removably attachable on the roof of a vehicle, on a rear bumper of a vehicle, or could be removably attachable to a trailer hitch receiver tube that has been previously mounted to the vehicle.

Bicycle hold down devices 24 are represented in FIG. 1. The bicycle hold down devices 24 hold the bicycle 18 down on the support rack 10 with the wheels 14, 16 of the bicycle engaged in the wheel channel 12. The typical hold down device 24 comprises an elongated shaft 26 having a proximal end 28 and an opposite distal end 32. The proximal end 28 is connected to the support rack 10 and the distal end 32 is engageable over a portion of the bicycle 18. For example, as represented in FIG. 1, the distal ends 32 of the hold down devices 24 are engageable over either the front wheel 14, the rear wheel 16 or a portion of the bicycle frame such as the crossbar 34. FIG. 1 represents three hold down devices 24 on the support rack 10. However, the support rack 10 could comprise just two hold down devices 24 that engage over the front wheel 14 and the rear wheel 16, or a single hold down device 24 that engages over the bicycle frame 34.

Each of the hold down devices 24 function in substantially the same manner. The distal ends 34 of the hold down devices 24 are positioned over either a bicycle wheel 14, 16 or the bicycle frame 34, and then the lengths of the shafts 26 are adjustably shortened. After adjusting the lengths of the shafts 26, the shafts 26 are secured in their adjusted length positions. This causes the distal ends 32 of the hold down devices 24 to hold the bicycle 18 down on the support rack 10 with the wheels 14, 16 engaging in the wheel channel 12.

However, road travel of the vehicle can cause vibration and movement of the bicycle 18 on the support rack 10. The movement of the bicycle 18 on the support rack 10 can cause the adjusted lengths of the shafts 26 of the hold down devices to increase, resulting in the distal ends 32 of the hold down devices disengaging from the bicycle and the bicycle falling from the support rack. For example, vibrations can cause the adjusted length of the shafts 26 to increase slightly causing the distal ends 32 of the hold down devices 24 to disengage from the wheels 14, 16 or the bicycle frame 34 allowing the bicycle to fall from the support rack 10. Furthermore, with the wheels 14, 16 positioned in the wheel channel 12 and the distal ends 32 of the hold down devices 24 engaged over one or both of the wheels 14, 16, or the bicycle frame 34, deflation of one or more of the wheels can cause the distal ends 32 of the hold down devices 24 to disengage from the wheel 16, 18 or frame 34 resulting in the bicycle 18 falling from the support rack 10 and the vehicle.

### SUMMARY OF THE INVENTION

The self-tensioning hold down apparatus of this disclosure provides an apparatus for securing an object to a support rack, for example securing a bicycle to a bicycle support rack. The self-tensioning hold down apparatus is designed for either a removable or permanent attachment to a bicycle support rack. The apparatus engages over a wheel or a portion of the frame of a bicycle on the support rack and securely holds the bicycle down on the support rack. The apparatus exerts a variable force on the bicycle that compensates for movement of the bicycle on the support rack due to vibration and maintains engagement with the bicycle as the bicycle vibrates or moves on the support rack. The variable force exerted by the apparatus on the bicycle also compensates for any loss of air pressure in the bicycle wheels. As a wheel or the wheels deflate, the length of the apparatus automatically decreases and maintains engagement of the apparatus with the bicycle holding the bicycle down on the support rack.

The hold down apparatus is described in several embodiments. In each embodiment a catch of the hold down apparatus engages against a portion of the bicycle supported on the support rack. The catch is spring biased and exerts a variable force against the portion of the bicycle engaged by the catch that urges the bicycle toward the support rack, thereby holding the bicycle down on the support rack.

The self-tensioning hold down apparatus comprises a shaft having a length with opposite proximal and distal ends. A connection is provided on the proximal end of the shaft. The connection operatively connects the proximal end of the shaft to the support rack. The connection can connect the shaft stationary to the support rack, or the connection can connect the shaft for pivoting movements of the shaft on the support rack.

A base is operatively connected to the shaft for movement of the base along the length of the shaft. The base can be adjustably positioned along the length of the shaft and includes a mechanism for securing the base in an adjusted position on the shaft.

The catch is mounted on the base which in turn mounts the catch on the shaft. In one embodiment the catch is mounted on the base for movement of the catch on the base toward and away from the proximal end of the shaft. The catch is configured for engaging against an object on the support rack, for example a wheel or a frame crossbar of a bicycle on the support rack in response to the catch moving on the base toward the proximal end of the shaft.

A biasing device is provided on the shaft. The biasing device is operative to bias the catch to exert a force against the object on the support rack engaged by the catch that biases the object toward the support rack and thereby grips the object between the catch and the support rack.

In one embodiment the biasing device is on the base and is operatively connected between the base and the catch. The biasing device is configured to push the catch toward the support rack and thereby is operative to exert a biasing force on the catch that biases the catch to move on the base toward the proximal end of the shaft and toward the support rack. The biasing device is a compression spring with opposite first and second ends. The first end of the spring is configured to exert a force against the base and the second end of the spring is configured to exert a force against the catch with the biasing device thereby being configured to push the catch toward the support rack.

In another embodiment the biasing device is on the catch and the catch is mounted stationary to the base. The catch has a hook formed on the catch that is configured to engage against the object supported on the support rack in response to the base being moved on the shaft toward the proximal end of the shaft. An elastic member biasing device is mounted on the catch with the elastic member extending across the hook. The hook positions the elastic member to engage against the object supported on the support rack and bias the object toward the support rack thereby gripping the object between the catch and the support rack.

In a further embodiment the biasing device is on the shaft and is operatively connected between the shaft and the support rack. The connection on the proximal end of the shaft is a pivot connection that operatively connects the proximal end of the shaft to the support rack for pivoting movement of the shaft on the support rack. The base is mounted on the shaft for movement of the base along the length of the shaft and the catch is mounted stationary on the base. The biasing device is coil spring operatively connected between the shaft and the support rack and is operative to pivot the shaft toward the support rack. The pivoting movement of the shaft engages the catch against the object supported on the support rack and exerts a force on the object gripping the object between the catch and the support rack.

In a still further embodiment the biasing device is on the shaft and is operatively connected between the shaft and the base. The connection on the proximal end of the shaft is a pivot connection that operatively connects the proximal end of the shaft to the support rack for pivoting movement of the shaft on the support rack. The base is mounted on the shaft for movement of the base along the length of the shaft and the catch is mounted stationary on the base. The biasing device is a rotor spring or torsion spring connected to a rod with the spring and rod operatively connected between the shaft and the base. The torsion spring and rod are operative to bias the base and the catch toward the support rack. The biased movement of the base and catch on the shaft engages the catch against the object supported on the support rack and exerts a force on the object gripping the object between the catch and the support rack.

The shaft can be a first shaft with a second shaft also operatively connected to the support rack. The second shaft has a length with a proximal end and a distal end at opposite ends of the length of the second shaft. The proximal end of the second shaft is operatively connected to the support rack. The second catch is provided on the distal end of the second shaft and is configured for engaging against the object on the support rack and holding the object on the support rack. The second biasing device is any of the previously described biasing devices and is provided on the second shaft and is configured for biasing the second catch toward the proximal end of the second shaft and gripping the object between the second catch and the support rack.

In a variant embodiment the self-tensioning hold down apparatus comprises a shaft having a length with opposite proximal and distal ends. A connection is provided on the proximal end of the shaft. The connection operatively connects the proximal end of the shaft to the support rack. The connection can connect the shaft stationary to the support rack, or the connection can connect the shaft for pivoting movements of the shaft on the support rack.

A base is mounted on the shaft for movement of the base along the length of the shaft. The base can be adjustably positioned along the length of the shaft and includes a mechanism for securing the base in an adjusted position on the shaft.

The catch is mounted on the base and in turn on the shaft. The catch is mounted stationery on the base. The catch is configured for engaging against the object on the support rack.

A pair of cradles configured for engaging beneath a portion of a bicycle wheel are provided on the wheel channel of the support rack. The pair of cradles are connected end to end by pivot connections. Torsion springs at the pivot connections bias the cradles upward about the pivot connections. With a bicycle positioned on the support rack and a wheel of the bicycle positioned on the cradles, the torsion springs urge the cradles upward and the wheel upward and bias the bicycle upwardly into engagement with the catch on the shaft. In this manner, the pair of cradles and the catch on the shaft grip the bicycle to the support rack.

The features, functions and advantages of the self-tensioning hold down apparatus that have been discussed can be achieved independently in various embodiments or may be combined in yet other embodiments, further details of which can be seen with reference to the following detailed description and the drawing figures.

### BRIEF DESCRIPTION OF DRAWINGS

FIG. 1 is a schematic representation of a prior art bicycle support rack.

FIG. 2 is a schematic representation of several possible positions of the self-tensioning hold down apparatus of this disclosure on a bicycle rack.

FIG. 3 is a representation of a perspective view of a first embodiment of the apparatus.

FIG. 4 is a representation of a side elevation view of the apparatus of FIG. 3.

FIG. 5 is a representation of an elevation view of the left side of the apparatus of FIG. 4.

FIG. 6 is a representation of a cross-section view of the apparatus of FIG. 3.

FIG. 7 is a representation of a side elevation view of a further embodiment of the apparatus.

FIG. 8 is a representation of a perspective view of a further embodiment of the apparatus.

FIG. 9 is a representation of a perspective view of a still further embodiment of the apparatus.

FIG. 10 is a representation of a cross-section view of the apparatus of FIG. 9.

FIG. 11 is a representation of a perspective view of a variant embodiment of the apparatus.

### DETAILED DESCRIPTION OF THE INVENTION

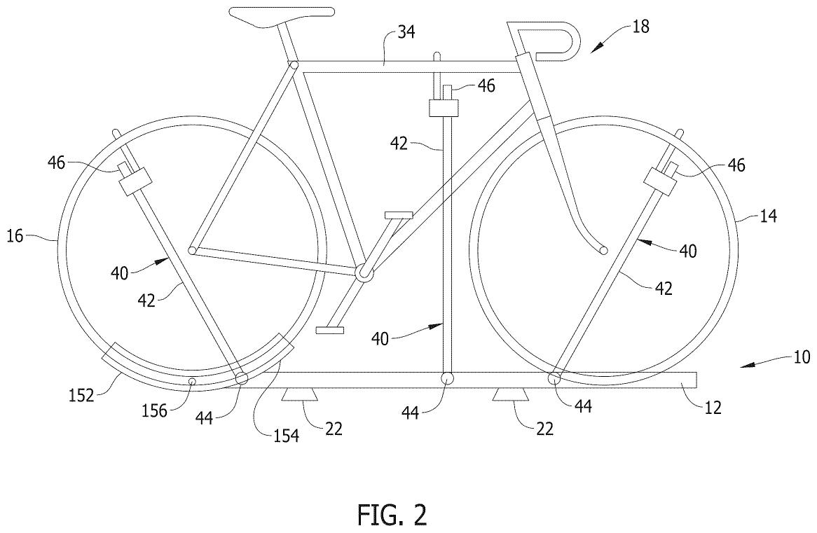

FIG. 2 is a schematic representation of the operative environment of the self-tensioning hold down apparatus 40 of this disclosure. The apparatus 40 is constructed of materials, for example metals, plastics, composite materials, or other equivalent types of materials that provide the apparatus with sufficient structural strength for functioning in its intended manner.

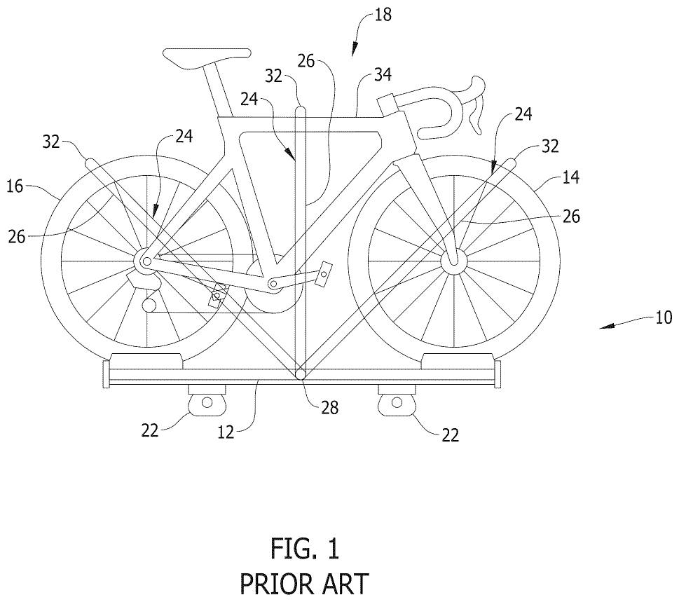

As represented in FIG. 2, the apparatus 40 is employed on a conventional bicycle support rack 10, although the concepts of the apparatus 40 can be employed in other types of hold down apparatus that are used to hold down objects on a support rack other than a bicycle support rack. The support rack 10 is substantially the same as the support rack 10 of FIG. 1 and comprises a wheel channel 12 having a U-shaped cross section configuration. The wheel channel 12 is dimension to receive the front wheel 14 and the rear wheel 16 of a bicycle 18 in the channel as represented in FIG. 1 and FIG. 2. The support rack 10 is supported on mounts 22 that are constructed to be removably attachable to the exterior of a vehicle.

Each embodiment of the apparatus 40 to be described comprises an elongate shaft 42 having a proximal end 44 and an opposite distal end 46. The proximal and 44 is constructed to be connected to the support rack 10 with the length of the shaft 42 positioning the distal end 46 adjacent a portion of the bicycle 18 supported on the support rack 10 where the apparatus 40 is engageable. For example, as represented in FIG. 2, the distal end 46 of the shaft 42 extends to a position adjacent the front wheel 14, the rear wheel 16 or a portion of the bicycle frame such as the crossbar 34. FIG. 2 represents three shafts 42 positioning the apparatus 40 adjacent to three different portions of the bicycle 18. However, it is not necessary that three apparatus 40 be used. The apparatus 40 is constructed to enable only one apparatus be used to hold the bicycle 18 to the support rack 10.

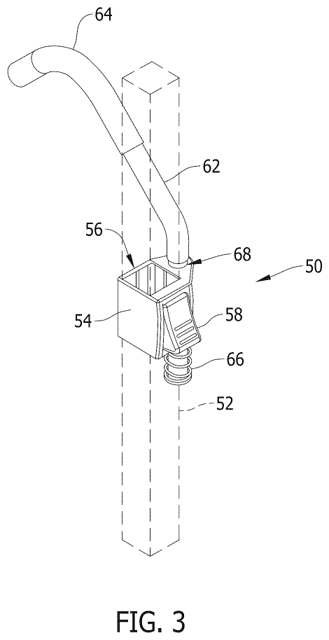

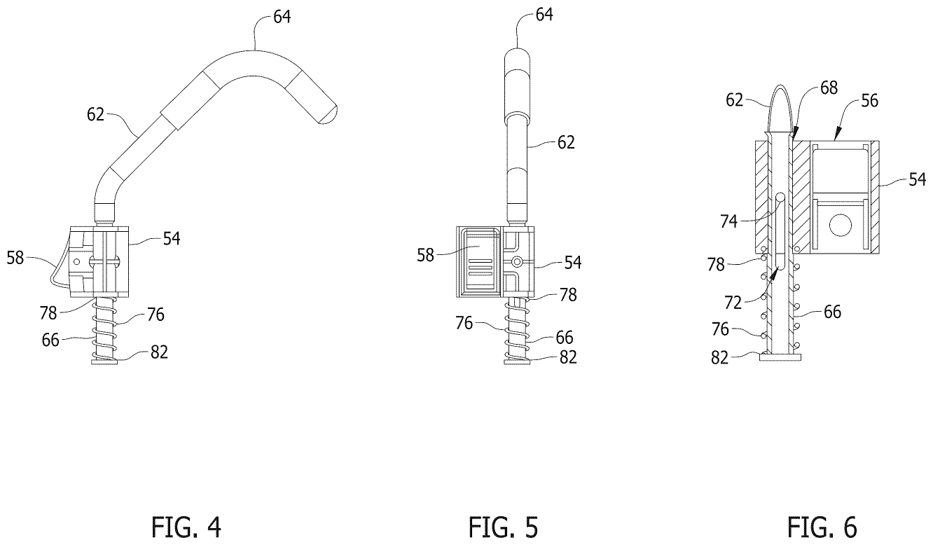

FIGS. 3-6 show representations of a first embodiment of the self-tensioning hold down apparatus 50 of this disclosure. The apparatus 50 is shown mounted on the distal end portion of a shaft 52 represented in dashed lines in FIG. 3. The shaft 52 has basically the same construction as the shafts 26, 42 previously described. A connection is provided on a proximal end of the shaft 52. The connection operatively connects the proximal end of the shaft 52 to the support rack 10. The connection can connect the shaft 52 stationary to the support rack, or the connection can connect the shaft for pivoting movements of the shaft on the support rack.

A base 54 is mounted on the shaft 52 for movement of the base along the length of the shaft. The base 54 has an interior channel 56 through the base. The channel 56 has a rectangular cross section that matches the rectangular cross section of the exterior of the shaft 52 and enables the base 54 to slide over the shaft 52 and be adjustably positioned along the length of the shaft. A ratchet tab 58 is provided on the base 54. The ratchet tab 58 can be manually depressed to lock the base 54 in an adjusted position on the shaft 52.

A catch 62 is mounted on the base 54 and thereby on the shaft 52. The catch 62 has a hook 64 formed on a distal end of the catch and has a straight cylindrical tube 66 formed at an opposite proximal end of the catch. The tube 66 as a cylindrical exterior surface that is received in a cylindrical bore 68 through the base 54 and adjacent the base interior channel 56. The tube 66 of the catch 62 received in the bore 68 of the base 54 enables the catch 62 to be adjustably positioned through the bore 68 on the base 54 and thereby enables the hook 64 to be adjustably positioned toward and away from the proximal end of the shaft 52. The hook 64 on the catch 62 is configured for engaging against an object on the support rack 10, for example a wheel 14, 16 or a frame crossbar of a bicycle 18 on the support rack in response to the catch 62 being adjustably positioned on the base 54 toward the proximal end of the shaft 52.

As represented in FIG. 6, there is a pair of slots 72 through opposite sides of the tube 66 on the catch 62. A pin 74 extends across the cylindrical bore 68 of the base 54 and through the slots 72. The pin 74 in the slots 72 enables limited reciprocating movements of the catch 62 in opposite directions through the base 54.

A coil spring 76 is mounted on the exterior of the tube 66 of the catch 64. The spring 76 has a first end 78 that engages against the base 54 and an opposite second and 82 that engages against an annular rim formed on the proximal end of the catch 62. The coil spring 76 biases the catch 62 downwardly from the base 54 as viewed in FIGS. 3-6 and biases the catch 62 toward the proximal end of the shaft 52.

In the embodiment of the apparatus 50 represented in FIGS. 3-6, the coil spring 76 is a biasing device on the base 54 that is operatively connected between the base and the catch 62. The coil spring 76 biasing device is configured to push the catch 62 toward the support rack 10 with the proximal end of the shaft 52 connected to the support rack, and thereby is operative to exert a biasing force on the catch 62 that biases the catch 62 to move on the base 54 toward the proximal end of the shaft 52 and toward the support rack 10. The coil spring 76 is a compression spring biasing device with a first end 78 and an opposite second end 82. The first end 78 of the spring 76 is configured to exert a force against the base 54 and the second end 82 of the spring 76 is configured to exert a force against the catch 62 with the biasing device of the coil spring 76 being configured to push the catch 62 toward the support rack 10.

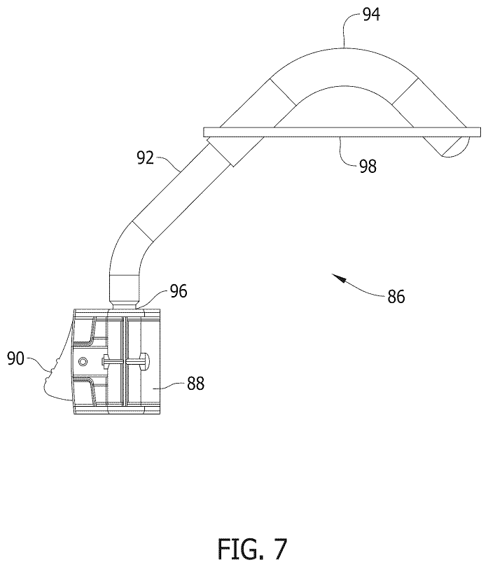

FIG. 7 is a representation of a further embodiment of the self-tensioning hold down apparatus 86. The apparatus 86 is mounted on the distal end portion of a shaft such as the shaft 52 represented in FIG. 3 or the previously described shafts 26, 42. The apparatus 86 comprises a base 88 that is mounted on the shaft for movement of the base along the length of the shaft. Just as in the previously described example of the base 54, the base 88 has an interior channel through the base. The channel receives the shaft in the channel and enables the base 88 to slide over the shaft to be adjustably positioned along the length of the shaft. A ratchet tab 90 is provided on the base 88. The ratchet tap 90 can be manually depressed to lock the base 88 in an adjusted position on the shaft.

A catch 92 is mounted on the base 88 and thereby on the shaft. The catch 92 is mounted stationary to the base 88. The catch 92 has a hook 94 formed on a distal end of the catch. The hook 94 is configured to engage against an object supported on the support rack in response to the base 88 being moved on the shaft toward the proximal end of the shaft. The catch 92 has a straight portion 96 on an opposite proximal end of the catch from the hook 94. The straight portion 96 of the catch 92 is secured stationary to the base 88.

An elastic member 98 biasing device is mounted on the catch 92 with the elastic member extending across the hook 94. The elastic member 98 has properties or characteristics that allow the elastic member to return to its original shape or size after being stretched, compressed or deformed. The elastic member 98 has the form of a strip of elastic material with holes through opposite ends of the strip. The hook 94 is inserted through the holes in the opposite ends of the strip of the elastic member 98 thereby mounting the elastic member on the hook. The hook 94 positions the elastic member 98 to engage against the object supported on the support rack and exert a force on the object that biases the object toward the support rack thereby gripping the object between the catch 92 and the support rack.

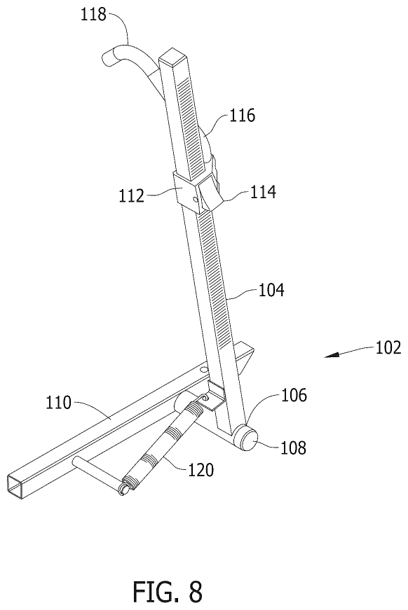

FIG. 8 is a representation of an embodiment of the self-tensioning hold down apparatus 102 in which the biasing device is on the shaft 104. As represented in FIG. 8, the shaft 104 of the apparatus has a proximal end 106 connected by a pivot connection 108 to a portion of the support rack 110. Only a portion of the support rack 110 is represented in FIG. 8, for example the wheel channel of the support rack. The pivot connection 108 operatively connects the proximal end 106 of the shaft 104 to the support rack 110 for pivoting movement of the shaft on the support rack.

A base 112 is mounted on the shaft 104 for adjustment movement of the base along the length of the shaft. Just as in previously described embodiments of the apparatus, a ratchet tab 114 is provided on the base 112. The ratchet tab 114 can be manually pressed to lock the base 112 in an adjusted position along the length of the shaft 104.

A catch 116 is mounted stationary on the base 112. The catch 116 has a hook 118 formed on a distal end of the catch.

The biasing device is a coil spring 120 that is connected between the shaft 104 and the support rack 110. The coil spring 120 is operative to pull the shaft 104 to the left as viewed in FIG. 8 and pivot the shaft counterclockwise around the pivot connection 108. The pivoting movement of the shaft 104 moves the hook 118 on the catch 116 toward the wheel of a bicycle or a frame of the bicycle supported on the support rack 110. The coil spring 120 is thereby operative to pivot the shaft 104 toward the support rack 110 and the wheel of a bicycle or the frame of the bicycle supported on the support rack until the hook 118 of the catch 116 engages against the object supported on the support rack and exerts a force on the object gripping the object between the catch 116 and support rack 110.

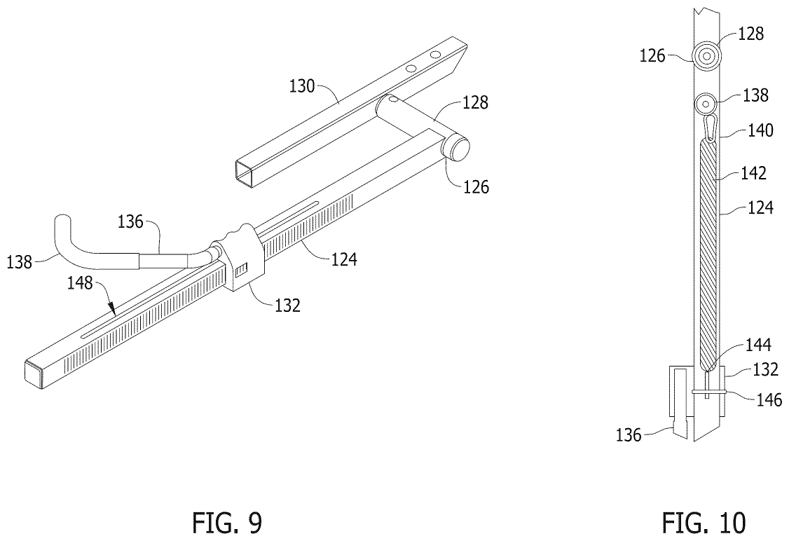

FIG. 9 is a representation of an embodiment of the apparatus that is similar to that of FIG. 8. In FIG. 9 the biasing device is also on the shaft 124. As represented in FIG. 9, the shaft 124 of the apparatus has a proximal end 126 connected by a pivot connection 128 to the support rack 130. Only a portion of the support rack 130 is represented in FIG. 9, for example the wheel channel of the support rack. The pivot connection 128 operatively connects the proximal end 126 of the shaft 124 to the support rack 130 for pivoting movement of the shaft 124 on the support rack.

Just as in previously described embodiments, the base 132 is mounted on the shaft 124 for adjustment movements of the base along the length of the shaft. A ratchet tab is provided on the base 132 and can be manually pressed to lock the base 132 in an adjusted position along the length of the shaft 124.

A catch 136 is mounted stationary on the base 132. The catch 136 has a hook 138 formed on the distal end of the catch.

The biasing device is a rotor spring or torsion spring 138 mounted inside the shaft 124 adjacent to the proximal end 126 of the shaft as represented in the cross section of the shaft of FIG. 10. The torsion spring 138 is connected to a first end 140 of an elongate, rigid rod 142 with a second end 144 of the rod being connected to the base 132. The second end 144 of the rod 142 is connected by a pin 146 that extends from the interior of the shaft 124 through slots 148 in opposite sides of the shaft 124 and into the base 132. The torsion spring 138 and the rod 144 are operative to bias the base 132 and the catch 136 toward the proximal end 126 of the shaft 124 and toward the support rack 130. The biased movement of the base 132 and the catch 136 on the shaft 124 engages the catch 136 against the object supported on the support rack 130 and exerts a force on the object gripping the object between the catch 136 and the support rack 130.

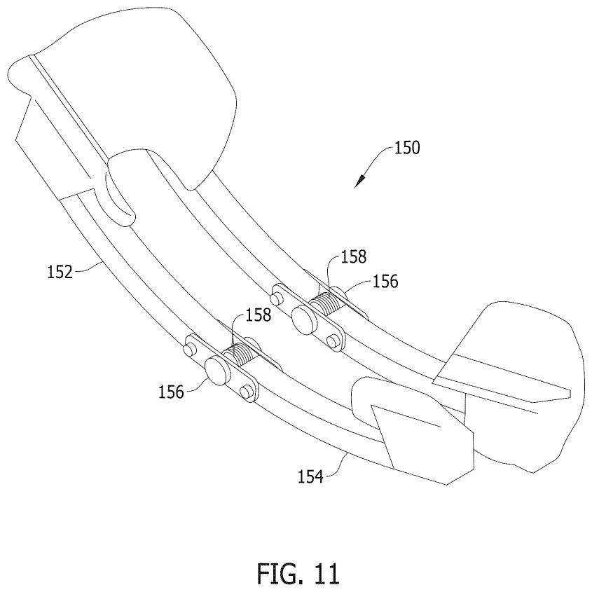

FIG. 11 is a representation of a perspective view of a variant embodiment of the self tensioning hold down apparatus 150. The apparatus 150 of FIG. 11 Is also used with a shaft, such as the previously described shafts 42 represented in FIG. 2, having a length with opposite proximal 44 and distal 46 ends. The shaft proximal end 44 is operatively connected to the support rack 12.

A base is mounted on the shaft for movement of the base along the length of the shaft. The base can be adjustably positioned along the length of the shaft and includes a mechanism for securing the base in an adjusted position on the shaft. The catch is mounted stationary on the base. The catch is configured for engaging against the object supported on the support rack.

The pair of cradles 152 represented in FIG. 11 are configured for engaging beneath a portion of a bicycle wheel 16 as represented in FIG. 2. The pair of cradles 152, 154 are provided on the wheel channel 12 of the support rack 10. The pair of cradles 152, 154 are connected end to end by a pivot connection 156. A torsion spring 158 is provided at the pivot connection 156 and biases the pair of cradles 152, 154 upward about the pivot connection. With a bicycle 18 positioned on the support rack 10 and a wheel 16 of a bicycle positioned on the cradles 152, 154, the torsion spring 158 urges the cradles upward and the cradles push the wheel of the bicycle upward causing the wheel or the frame of the bicycle to engage against the catch on the shaft 42 of the hold down apparatus 40. In this manner, the pair of cradles 152, 154 and the catch on the shaft of the hold down apparatus grip the bicycle between the cradles and the catch and thereby secure the bicycle to the support rack 10.

As various modifications could be made in the construction of the self-tensioning hold down apparatus and its method of operation herein described and illustrated without departing from the scope of the invention, it is intended that all matter contained in the foregoing description or shown in the accompanying drawings shall be interpreted as illustrative only rather than limiting. Thus, the breadth and scope of the present disclosure should not be limited by any of the above described exemplary embodiments, but should be defined only in accordance with the following claims appended hereto and their equivalents.

1. An apparatus for securing an object on a support rack, the apparatus comprising:
a shaft;
a connection on the shaft, the connection operatively connecting the shaft to a support rack;
a catch on the shaft, the catch being configured for engaging against an object on the support rack; and
a biasing device on the shaft, the biasing device being operative to bias the catch toward the support rack to exert a force against the object on the support rack biasing the object toward the support rack and thereby gripping the object between the catch and the support rack.

2. The apparatus of claim 1, further comprising:
the biasing device being configured to pull the catch toward the support rack.

3. The apparatus of claim 1, further comprising:
the biasing device being configured to push the catch toward the support rack.

4. The apparatus of claim 1, further comprising:
the shaft having a length with opposite proximal and distal ends;
the connection being on the proximal end of the shaft and operatively connecting the proximal end of the shaft to the support rack;
a base mounted on the shaft for movement of the base along the length of the shaft;
the catch being mounted on the base for movement of the catch on the base toward and away from the proximal end of the shaft;
the biasing device operatively connected between the base and the catch, the biasing device being operative to exert a force on the catch and biasing the catch to move on the base toward the proximal end of the shaft and toward the support rack.

5. The apparatus of claim 4, further comprising:
the biasing device being a compression spring with opposite the first and second ends, the first end of the compression spring being configured to exert a force against the base and the second end of the compression spring being configured to exert a force against the catch.

6. The apparatus of claim 1, further comprising:
the shaft having a length with opposite proximal and distal ends;
the connection being on the proximal end of the shaft and operatively connecting the proximal end of the shaft to the support rack;
a base mounted on the shaft for movement of the base along the length of the shaft;
the catch being mounted on the base;
a biasing device mounted on the catch, the biasing device being positioned on the catch to engage and exert a force on the object on the support rack that biases the object toward the support rack in response to the base being moved on the shaft toward the proximal end of the shaft.

7. The apparatus of claim 6, further comprising:
the catch having a hook formed on the catch, the hook being configured to engage against the object supported on the support rack in response to the base being moved on the shaft toward the proximal end of the shaft; and
the biasing device being an elastic member on the catch that extends across the hook to engage against the object supported on the support rack and bias the object toward the support rack and thereby gripping the object between the catch and the support rack.

8. The apparatus of claim 1, further comprising:
the shaft having a length with opposite proximal and distal ends;
the connection being a pivot connection on the proximal end of the shaft, the pivot connection operatively connecting the proximal end of the shaft to the support rack for pivoting movement of the shaft on the support rack;
a base mounted on the shaft for movement of the base along the length of the shaft;
the catch being mounted on the base;
the biasing device being operatively connected between the shaft and the support rack, the biasing device being operative to pivot the shaft on the support rack and engage the catch against the object supported on the support rack and exert a force on the object forcing the object toward the support rack and thereby gripping the object between the catch and the support rack.

9. The apparatus of claim 1, further comprising:
the shaft having a length with opposite proximal and distal ends;
a base mounted on the shaft for movement of the base along the length of the shaft;
the catch being mounted on the base;
the biasing device being operatively connected between the shaft and the base, the biasing device being operative to bias the base on the shaft toward the support rack and engage the catch against the object supported on the support rack and exert a force on the object forcing the object toward the support rack and thereby gripping the object between the catch and the support rack.

10. An apparatus for securing an object on a support rack, the apparatus comprising:
a shaft, the shaft having a length with a proximal end and a distal end at opposite ends of the length of the shaft;
the proximal end of the shaft being operatively connected to the support rack;
a catch on the distal end of the shaft, the catch being configured for engaging against an object on the support rack and holding the object on the support rack; and
a biasing device on the shaft, the biasing device being configured for biasing the catch toward the proximal end of the shaft and gripping the object between the catch and the support rack.

11. The apparatus of claim 10, further comprising:
the biasing device being configured to pull the catch toward the proximal end of the shaft.

12. The apparatus of claim 10, further comprising:
the biasing device being configured to push the catch toward the proximal end of the shaft.

13. The apparatus of claim 10, further comprising:
the shaft being a first shaft;
a second shaft having a length with a proximal end and a distal end at opposite ends of the length of the second shaft;
the proximal end of the second shaft being operatively connected to the support rack;
a second catch on the distal end of the second shaft, the second catch being configured for engaging against the object on the support rack and holding the object on the support rack;
a second biasing device on the second shaft, the second biasing device being configured for biasing the second catch toward the proximal end of the second shaft and gripping the object between the second catch and the support rack.

14. The apparatus of claim 10, further comprising:
the support rack being a bicycle support rack;
the object on the support rack being a bicycle on the bicycle support rack; and
the biasing device being configured for gripping the bicycle between the catch and the bicycle support rack.

15. The apparatus of claim 10, further comprising:
the biasing device being a compression spring with opposite the first and second ends, the first end of the compression spring being configured to exert a force against the base and the second end of the compression spring being configured to exert a force against the catch.

16. The apparatus of claim 10, further comprising:
a base mounted on the shaft for movement of the base along the length of the shaft;
the catch being mounted on the base;
a biasing device mounted on the catch, the biasing device being positioned on the catch to engage and exert a biasing force on the object on the support rack that biases the object toward the support rack in response to the base being moved on the shaft toward the proximal end of the shaft.

17. The apparatus of claim 16, further comprising:
the catch having a hook formed on the catch, the hook being configured to engage against the object supported on the support rack in response to the base being moved on the shaft toward the proximal end of the shaft; and
the biasing device being an elastic member on the catch that extends across the hook to engage against the object supported on the support rack and bias the object toward the support rack and thereby gripping the object between the catch and the support rack.

18. The apparatus of claim 10, further comprising:
a pivot connection on the proximal end of the shaft, the pivot connection operatively connecting the proximal end of the shaft to the support rack for pivoting movement of the shaft on the support rack;
a base mounted on the shaft for movement of the base along the length of the shaft;
the catch being mounted on the base;
the biasing device being operatively connected between the shaft and the support rack, the biasing device being operative to pivot the shaft on the support rack and engage the catch against the object supported on the support rack and exert a force on the object forcing the object toward the support rack and thereby gripping the object between the catch and the support rack.

19. The apparatus of claim 10, further comprising:
a base mounted on the shaft for movement of the base along the length of the shaft;
the catch being mounted on the base;
the biasing device being operatively connected between the shaft and the base, the biasing device being operative to bias the base on the shaft toward the support rack and engage the catch against the object supported on the support rack and exert a force on the object forcing the object toward the support rack and thereby gripping the object between the catch and the support rack.

20. An apparatus for securing a bicycle on a bicycle support rack, the apparatus comprising:
a shaft;
a connection on the shaft, the connection operatively connecting the shaft to a bicycle support rack;
a catch of the shaft, the catch being configured for engaging against a bicycle on the bicycle support rack;
a pair of cradles on the support rack, the pair of cradles being configured to engage underneath a wheel of the bicycle on the bicycle support rack; and
a biasing device operatively connected between the pair of cradles, the biasing device being operative to bias the pair of cradles together and exert a biasing force against the wheel of the bicycle on the support rack biasing the bicycle upward toward the catch and thereby gripping the bicycle between the catch and the support rack.
